(19) United States
(12) Patent Application Publication
(10) Pub. No.: US 2002/0083884 A1
(43) Pub. Date: Jul. 4, 2002

(54) Combination pen holder and bookmark/placesaver

(76) Inventor: Lucinda Charmay McClosky, Spring, TX (US)

Correspondence Address: Mary J. Gaskin, Suite 220, 2170 Buckthorne Place, The Woodlands, TX, 77380, US

(21) Appl. No.: 09/750,561

(22) Filed: Dec. 28, 2000

(51) Int. Cl. B42D 9/00

(52) U.S. Cl. 116/235; 116/239; 281/42

(57) ABSTRACT

A bookmark/placesaver in combination with a holder for writing implements is disclosed. The holder portion includes a strip of material with complementary mating elements. The strip of material is wrapped around the front cover of a book and the mating elements are attached. An optional lengthening element allows the device to be used on large books. A bookmark with a placesaver allows the reader to mark a page and passage of a book. An optional magnifier can be included on the placesaver.

### BACKGROUND OF THE INVENTION

The invention relates to a pen/pencil/marker holder in combination with a bookmark/placesaver, which optionally includes a magnifying lens.

Readers often wish to underline or mark passages or to jot notes in margins. They would value the convenience of having a device to store a pen or highlighter with books they are reading.

A reader would also find a bookmark useful for marking the page he has finished reading. Even more useful would be a bookmark which acts as a placesaver, indicating the very passage which one has completed.

A device which combines these functions would be especially useful. Combination pen holders/bookmarks have been disclosed in the prior art, for example, Fred P. Gonot, Jr. et al., U.S. Pat. No. 4,162,800; Kip H. Dopps, U.S. Pat. No. 4,706,995; John R. Knight, U.S. Pat. No. 5,095,846; Linda S. Leake, U.S. Pat. No. 5,501,171; and Douglas E. Rigvey, U.S. Pat. No. 5,881,434. However, none of these are especially easy to use, and several could damage the spines or pages of the books with which they are used. In particular, U.S. Pat. No. 4,162,800 discloses a bookmark/holder which functions like a giant rubber band, having slits or openings for a pen. The elastic portion could damage pages, and the pen, which is poorly secured, could easily be lost. None of them disclose a placesaver.

### SUMMARY OF THE INVENTION

The present invention has a strip of material, with an optional elastic segment, the ends of which are wrapped around the cover of a book and fastened together with complementary Velcro™ strips. An optional telescoping strip with Velcro™ allows the present invention to be used on large books. A pocket for holding one or more pens or markers is mounted on the front section of the strip. A ribbon of material is attached to the front section of the strip. The ribbon is used as a bookmark. Threaded onto the ribbon is a placesaver arrow, which can be used to indicate the passage of the book which the reader last read. An optional magnifier can be mounted onto the arrow.

It is an object of the present invention to provide a utilitarian, yet attractive, combination pen holder and bookmark/placesaver, which gives a reader easy access to and storage of writing instruments, as well as a device for relocating the page of the book, as well as the last passage, that he has read.

It is yet another object of the invention to provide a combination pen holder and bookmark/placesaver which is easy to install and is easy to use.

A further object of the invention is to provide a combination pen holder and bookmark/placesaver which is adjustable, depending on the size of the book.

Other objects of the invention will become obvious when the embodiment is more fully described in the specifications.

### BRIEF DESCRIPTION OF THE DRAWINGS

FIG. 1 is a perspective view showing the combination pen holder and bookmark/placesaver of the present invention.

FIG. 2 is a perspective view of an open book, showing the bookmark/placesaver portion in use.

FIG. 3 is a perspective view showing the combination penholder and bookmark/placesaver of the present invention, showing the elastic portion and also the Velcro™ strips and circles.

FIGS. 4A-4B are details showing the optional adjustable telescoping Velcro™ strip.

FIG. 5 is a detail showing the optional magnifier attached to the placesaver arrow.

FIGS. 6A-6D show the method of using the combination pen holder and bookmark/placesaver of the present invention. In FIG. 6A, the open strip of material has been laid on the inside of a book cover, and the bookmark/placesaver has been inserted to point to a passage in the book. In FIG. 6B, the bookmark ribbon has been pulled down and the book has been closed. In FIG. 6C, the lower portion of the invention has been folded over the front cover of the book. In FIG. 6D, the upper portion of the device has been pulled over and affixed to the lower portion. Two pens have been inserted into the holding pocket, and the flap is ready to be closed.

### DESCRIPTION OF PREFERRED EMBODIMENT

Referring to the drawings, the combination pen holder and bookmark/placesaver of the present invention is referred to generally as the device 1. The device 1 has been wrapped around the cover 2 of a book 3, and the book 3 has been closed. Two writing instruments 4a, 4b, which can be pens, pencils, markers, highlighters, or other such implements, have been stored in the pocket 5 of the device 1. A flap 6 which can be closed over the writing instruments 4a, 4b has been attached to top strap 7, by sewing or other means. Velcro™ circles 8a, 8b can be used to keep the flap 6 closed. The pocket 5 is fastened to the bottom strap 9 with Velcro™ strips 10a (not shown), 10b. A ribbon 11, which functions as a bookmark, is attached to the top strap 7, by sewing or other means. The device 1 is shown and described in more detail infra.

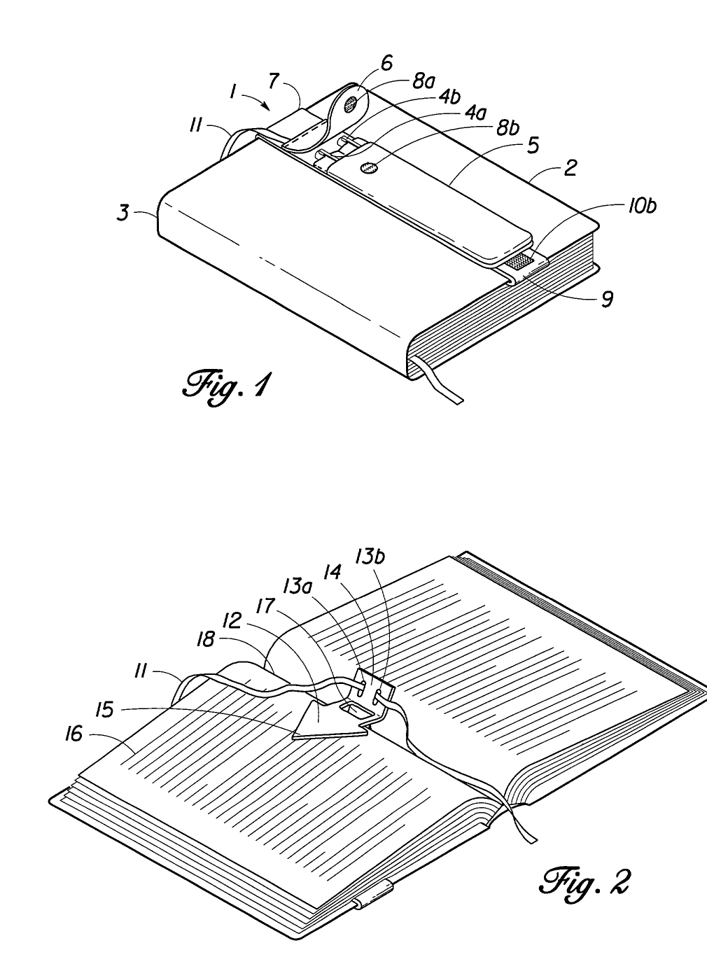

The bookmark ribbon 11 and the placesaver arrow 12 are shown in FIG. 2. The ribbon 11 has been inserted through openings 13a, 13b in the extension 14 of the placesaver arrow 12. The pointer 15, the end of the placesaver arrow 12, is placed next to the portion of the text 16 which the reader wishes to “mark” (i.e., he has just finished the passage or he will return to the passage when he resumes reading). The stiff insert 17 has been pushed into the crease 18 between the pages of the book 3 to keep the placesaver arrow 12 from moving around. The end of the ribbon 11 can be pulled down to dangle past the bottom edge of the book 3; the ribbon will move freely through the openings 13a, 13b of the placesaver arrow 12.

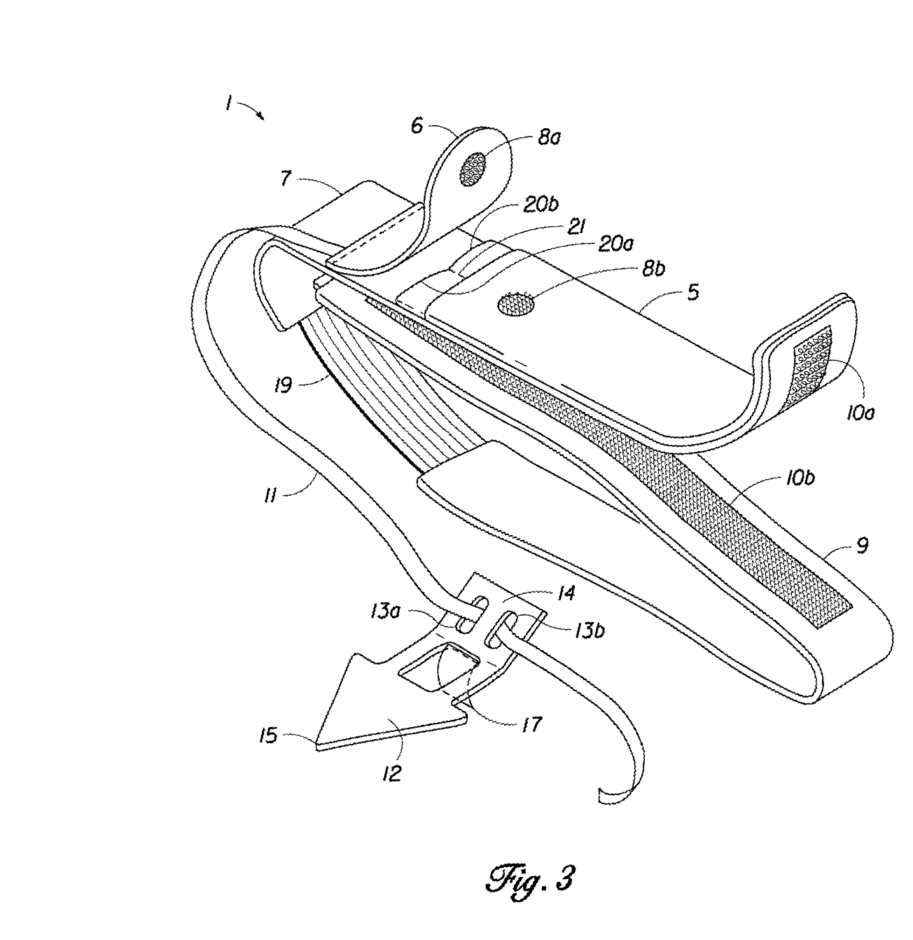

As shown in FIG. 3, the device 1 is assembled in a unitary fashion. The pocket 5, the flap 6, the top strap 7, and the bottom strap 9 are generally made from a fabric material, which can be selected from patterned fabrics for added attractiveness. These pieces can also be made from sturdier materials, such as leather or plastic.

A piece of flat elastic 19 connects the top strap 7 and the bottom strap 9, allowing the reader to slightly stretch the elastic strip 19 and thereby snugly attach the device I to a book cover when mating the Velcro™ strips 10a, 10b. A second partitioned pocket 20a, 20b can be created by adding additional material and sewing a divider seam 21. The partitioned pocket 20a, 20b can hold two pens, while the main pocket 5 holds one large writing instrument or other implement.

The ribbon 11 shown is typically made from fabric material. The placesaver arrow 12 is generally made of the same material as the pocket 5, the flap 6, the top strap 7, the bottom strap 9, such as fabric, leather or plastic. The stiff insert 17 is made of plastic. The extension 14 and the arrow 12 may be reinforced with additional material or plastic.

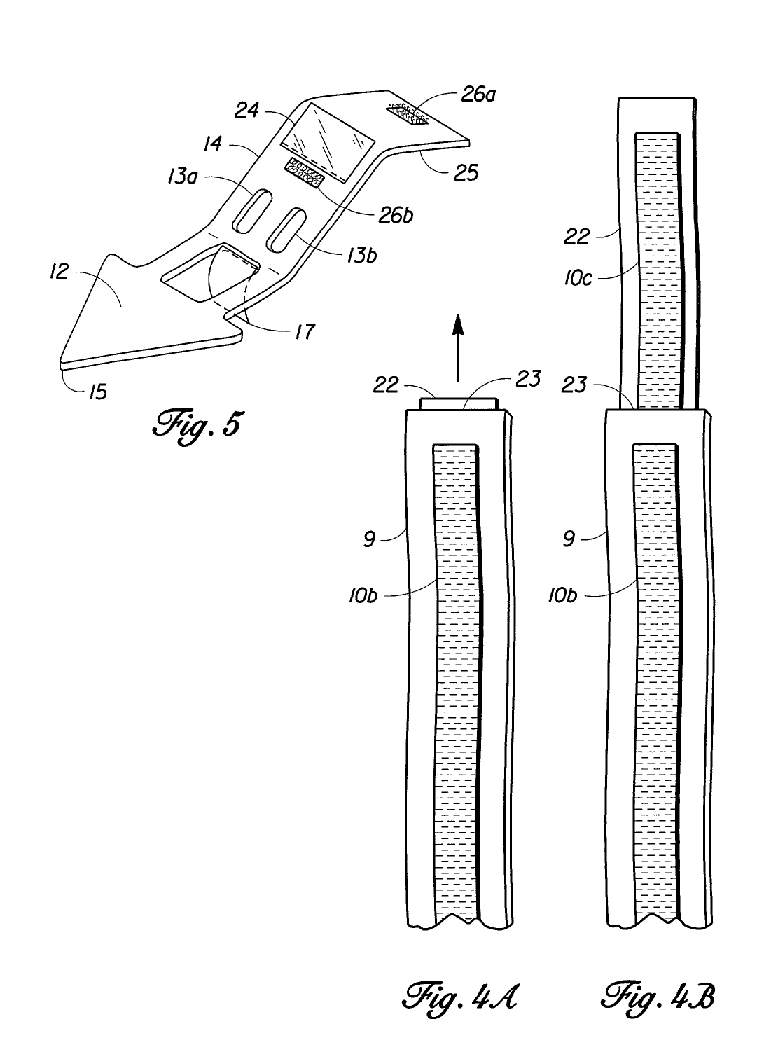

FIGS. 4A-4B show an optional feature to make the device 1 adjustable for use with a larger book. A telescoping strip 22 covered with an additional Velcro™ strip 10c can be inserted into a slit 23 formed at the free end of bottom strap 9. The telescoping strip 22 can be slid out to add length to the Velcro™ strip 10b on the bottom flap 9, thereby allowing improved mating with the Velcro™ strip 10a on top strap 7, particularly when the reader is using the device 1 with a large book.

FIG. 5 shows a optional magnifier, which can be used to enhance the usefulness of the placesaver arrow 12. A side of a rectangular magnifier 24, made from plastic or glass, can be attached to the extension 14 of the placesaver arrow 12, ordinarily by sewing or gluing. A protective flap 25, comprising a long rectangular piece of material, is also attached to the extension 14, under the magnifier 24. The Velcro™ closure 26a on the end of the protective flap 25 mates with a Velcro™ closure 26b on the extension 14, allowing the reader to fold the protective flap 25 over the magnifier 24, to prevent scratching its surface. The reader can pull back the protective flap 25 and use the magnifier 24 to read small type.

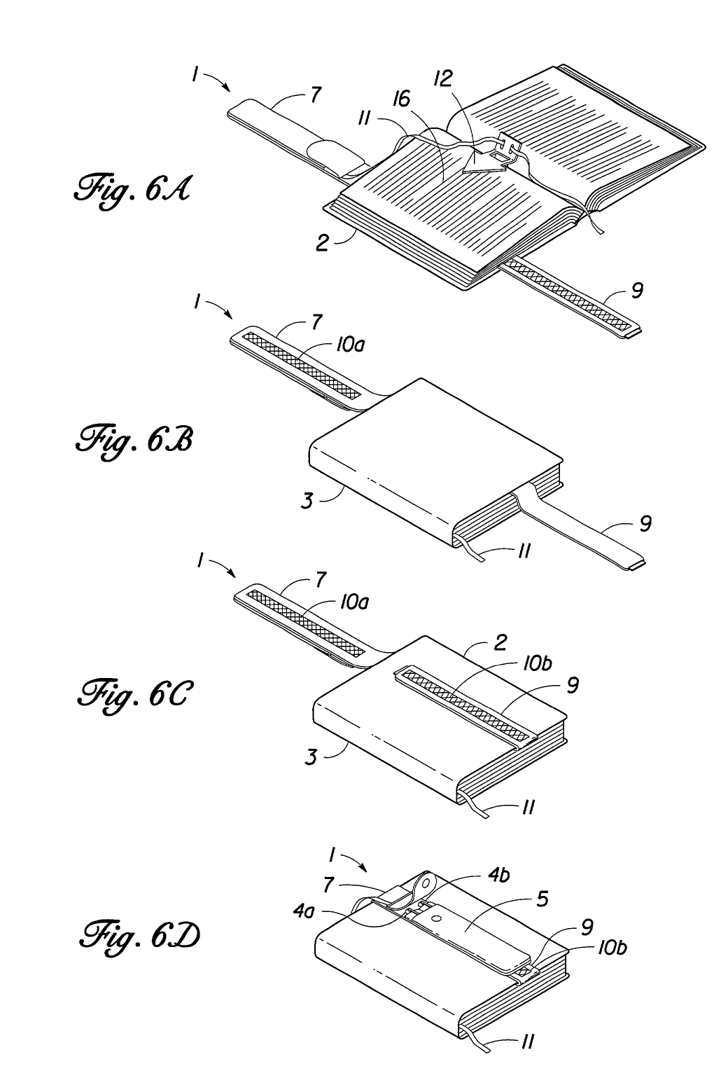

As shown in FIG. 6A, the reader has laid the length of the device 1 over the inside of a book cover 2. He has used the bookmark ribbon 11 to mark a page and has used the placesaver arrow 12 to mark a place in the text 16.

In FIG. 6B, the book 3 has been closed. The bookmark ribbon 11 marks the page.

In FIG. 6C, the bottom strap 9 has been folded over the front of the book cover 2.

In FIG. 6D, the top strap 7, with the pocket 5, has been folded over the bottom strap 9, pulled tight, and secured thereto with Velcro™ strips 10a (not shown), 10b. Pens 4a, 4b have been inserted into the pocket 5.

I claim:

1. A combination holder and bookmark for use with a book having a spine and a front cover with a height parallel to the spine, comprising:
a strip having a front face and a back face and having a length at least two times as long as the height of the front cover, the strip having a first inelastic segment; a second elastic segment, and a third inelastic segment;
a first fastening element attached to the back face of the first inelastic segment;
a second fastening element complementary to the first fastening element, said second fastening element attached to the front face of the third inelastic segment;
a pocket formed on the front face of the first inelastic segment, said pocket having an opening;
a fabric ribbon having a first end and a second end, the first end being attached to the front face of the first inelastic segment.

2. The combination holder and bookmark of claim 1 wherein the first fastening element and the second fastening element comprise a system selected from the group consisting of a loop and hook fastening system, a hook and eye fastening system, and a system of complementary snaps.

3. The combination holder and bookmark of claim 1 further comprising a bendable, arrow-shaped placesaver having a triangular portion, an extension with openings through which the second end of the ribbon is threaded, and a stiff rectangular insert attached to the placesaver.

4. The combination holder and bookmark of claim 1 which further comprises:
a flap attached to the front face of the first inelastic segment, said flap extending over the opening of the pocket;
means for removably attaching the flap to the pocket.

5. The combination holder and bookmark of claim 4 wherein the means for removably attaching the flap to the pocket is selected from the group consisting of a loop and hook fastening system, a hook and eye fastening system, and a system of complementary snaps.

6. The combination holder and bookmark of claim 3, wherein the arrow-shaped placesaver further comprises a rectangular magnifier and protective covering, both attached to the extension.

7. The combination holder and bookmark of claim 1 wherein the third inelastic segment has an unattached end with an opening for accommodating a telescoping, rigid strip having a front face with a fastening element which supplements the second fastening element attached to the first face of the third inelastic segment.

8. The combination holder and bookmark of claim 7 wherein the fastening elements comprise a loop and hook fastening system.
